(19) United States
(12) Patent Application Publication
(10) Pub. No.: US 2025/0365247 A1
(43) Pub. Date: Nov. 27, 2025

(54) Session Discovery of Packetization Layer Path Maximum Transmission Unit (PLPMTU) Size

(71) Applicant: Citrix Systems, Inc., Fort Lauderdale, FL (US)

(72) Inventors: Rakesh Ranjan Jha, San Jose, CA (US); Sridharan Rajagopalan, Pompano Beach, FL (US); Daniel Wing, Truckee, CA (US)

(21) Appl. No.: 18/669,769

(22) Filed: May 21, 2024

(51) Int. Cl. H04L 47/36; H04L 47/34; H04L 47/43

(52) U.S. Cl. CPC H04L 47/36; H04L 47/34; H04L 47/43

(57) ABSTRACT

Methods and systems for in session packet adjustment are described. A computing system may establish, between a client device and a server, a packet transport session. The computing system may detect, during the packet transport session, that a threshold number of packets have failed to successfully transmit between the client device and the server, where a size each of the failed packets exceeds a predetermined size, and where the packets are transmitted according to a first MTU. The computing system may identify, during the packet transport session and based on a largest packet that successfully travelled between the client device and the server, a second MTU, smaller than the first MTU. The computing system may resize, during the packet transport session, further packets according to the second MTU. The computing system may transmit, during the packet transport session, the further packets between the client device and the server.

### FIELD

Aspects described herein generally relate to computer networking, remote computer access, virtualization, enterprise mobility management, and hardware and software related thereto. More specifically, one or more aspects described herein include a method for identifying a packetization layer path maximum transmission unit (MTU) size and dynamically adjusting packets accordingly.

### BACKGROUND

In some instances, information may be sent between systems using internet protocol (IP) packets. For a given transmission path, there may be a path maximum transmission unit (MTU), which may be understood as an effective MTU for sending IP packets that is honored by every network element in the path.

In some instances, over the lifetime of a remote and/or other virtual session, the path MTU may change depending on how packets are routed. In instances where this path MTU is reduced, packets exceeding this size may be fragmented at the IP layer and/or otherwise dropped, which may cause protocol/network disruption or performance degradation.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards in session discovery of packetization layer path maximum transmission unit (PLPMTU) size, and dynamic adjustment of packet sizes accordingly.

In one or more instances, a computing system having one or more processors and memory storing computer-readable instructions that, when executed by the one or more processors, cause the computing system to establish a packet transport session between a client device and a server, and the computing system may be one of the client device or the server. The computing system may detect, during the packet transport session, that a threshold number of packets have failed to successfully transmit between the client device and the server, where the size of each of the failed packets may exceed a predetermined size, and where the packets may be transmitted according to a first maximum transmission unit (MTU). The computing system may identify, while continuing to transmit additional packets during the packet transport session and based on a largest packet that successfully travelled between the client device and the server, a second MTU, smaller than the first MTU. The computing system may resize, during the packet transport session, further packets according to the second MTU. The computing system may transmit, during the packet transport session, the further packets between the client device and the server.

In one or more examples, the computing system may identify that a negative acknowledgement (NAK) is received for a first packet. The computing system may identify, based on the NAK, that the first packet failed to successfully transmit between the client device and the server.

In one or more instances, the computing system may identify whether a size of the first packet exceeds a minimum threshold. Based on identifying that the size of the first packet exceeds the minimum threshold, the computing system may trigger a rediscovery process to identify the second MTU.

In one or more examples, detecting that the threshold number of packets have failed to successfully transmit between the client device and the server may include: increasing, each time a failed transmission is detected, a failure count; and identifying that the failure count equals the threshold number. In one or more examples, the computing system splits an original packet into multiple smaller packets, where the detection that the threshold number of packets have failed to successfully transmit between the client device and the server may occur during the transmission of the original packet. The computing system may transmit the multiple smaller packets rather than the original packet, where the multiple smaller packets are successfully transmitted between the client device and the server. In one or more instances, where an upper protocol uses packet numbers, the multiple smaller packets may be renumbered once the original packet is split, and the upper protocol may re-synchronize, following the renumbering, a packet number to signal an initial packet and discards out of order packets that were not renumbered.

In one or more instances, identifying the second MTU, smaller than the first MTU may occur during a MTU discovery process, and initiating the MTU discovery process may be based on identifying that a plurality of packets to be retransmitted exceeds the predetermined size. In one or more instances, identifying the second MTU, smaller than the first MTU may occur during a MTU discovery process, and initiating the MTU discovery process may be based on detecting an increase in a number of lost packets.

In one or more examples, identifying the second MTU, smaller than the first MTU may occur during a MTU discovery process, and initiating the MTU discovery process may be based on detecting an internet control message protocol (ICMP) packet-too-big message. In one or more examples, the largest packet may be identified based on an acknowledgement (ACK) message received for the largest packet. In one or more examples, the largest packet may be identified based on identifying that the largest packet comprises a largest packet for which a NAK is not received.

In one or more instances, identifying the second MTU may include identifying, based on a lower bound and an upper bound, the second MTU. The lower bound and the upper bound may be identified while waiting for a threshold number of packet transmission failures. The upper bound may be identified based on a packet size of a smallest packet for which failure is detected while waiting for the threshold number of packet transmission failures. The lower bound may be identified based on a packet size of a largest packet acknowledged while waiting for the threshold number of packet transmission failures.

In one or more examples, identifying the second MTU may be further based on historical information including one or more of: device information, time information, network condition information, or machine identifier information, and corresponding final MTU information.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative computing environment for performing in session discovery of packetization layer path maximum transmission unit (PLPMTU) size in accordance with one or more illustrative aspects described herein.

FIGS. 6A-6C depict an illustrative event sequence for performing in session discovery of packetization layer path maximum transmission unit (PLPMTU) in accordance with one or more illustrative aspects described herein.

FIG. 7 depicts an illustrative method for performing in session discovery of packetization layer path maximum transmission unit (PLPMTU) in accordance with one or more illustrative aspects described herein.

FIG. 8 depicts an illustrative diagram for resetting packet numbers of previously-generated packets (which were generated for the previously-larger MTU).

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards dynamically identifying a path maximum transmission unit (MTU) in session, and adjusting packet sizes accordingly. For example, path MTU may be understood as effective MTU for sending IP packets that may be honored by every network element in the path. For example, a path between a client and server in a virtual desktop and/or other remote session may traverse a number of intermediary devices, network tunnels, or the like, which may each support different MTUs.

A client or host sending datagrams much smaller than the allowed path MTU may be wasting network resources and achieving suboptimal throughput and/or interactivity, whereas sending packets larger than the path MTU may lead to packet fragmentation. IP fragmentation may lead to loss and/or retransmission of packets, which may in turn lead to inefficiencies, black hole encounters, connection failures, or the like.

A packetization protocol may have responsibility for preventing this fragmentation by determining the maximum working path MTU between a client and the server and choosing the packet boundaries (e.g., frame sizes) accordingly. While such a determination may be performed during initial configuration, there is no existing solution for identifying the path MTU during a session where the path changes due to rerouting, failovers, or the like.

For example, the path MTU may change during the lifetime of a session depending on the way packets are routed. For example, the connection between a server and client may go over a cloud infrastructure. In this example, the initial connection may have been established (over path A) with an MTU of 1500 bytes, which may have been discovered at the start of the session, and packet sizes may have been set accordingly. However, while the session is in progress, the cloud network nodes may decide to route the packets across a different path (over path B) with an MTU of 1200 byes. This may cause packets over the size of 1200 bytes to be fragmented at the IP layer or even dropped, based on how the intermediary nodes handle fragmentation, which ultimately may cause performance degradation. A similar issue may occur when nodes silently switch a session from one point-of-presence (POP) to another due to planned or unplanned shutdown. In these instances, a rediscovery may handle session migration better than sending a reset to end points to initiate a fresh connection, which may involve unnecessary steps such as authentication, resource identification, authorization, or the like.

With the growth of cloud adoption, more and more connections are migrating to a cloud infrastructure, and the occurrences of such changes are becoming increasingly prominent. Accordingly, described herein is a method for in session re-discovery of packetization layer path MTU (PLPMTU).

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

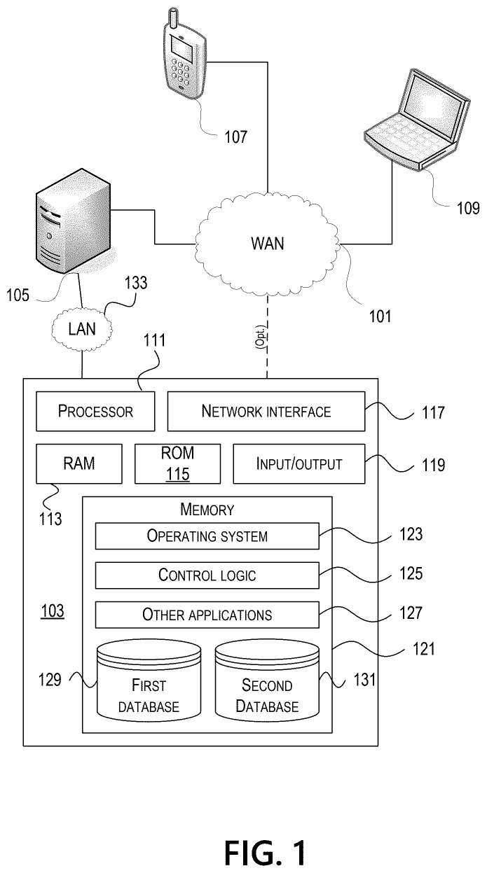

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity-which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

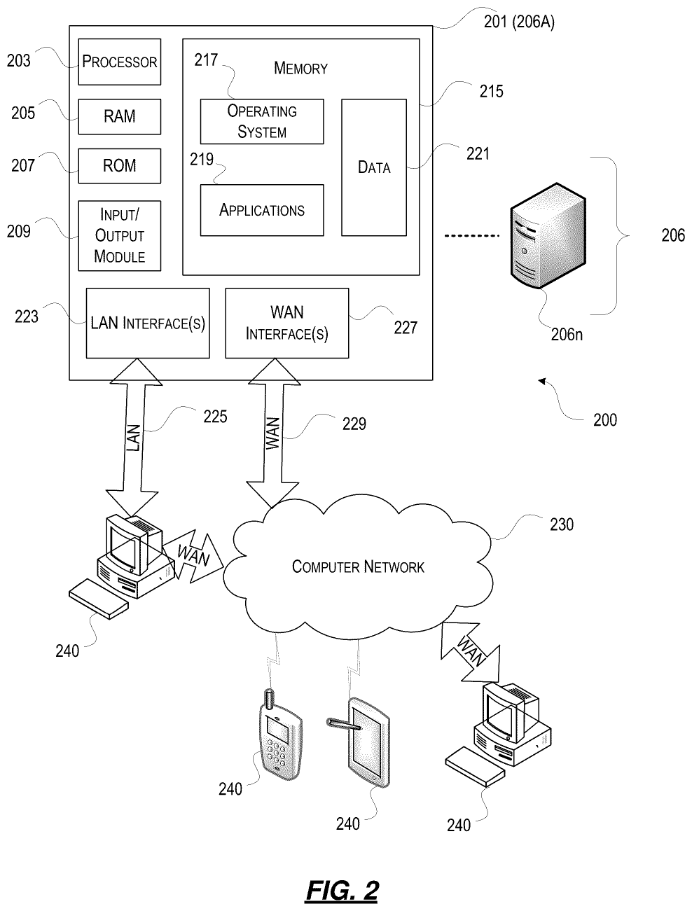

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

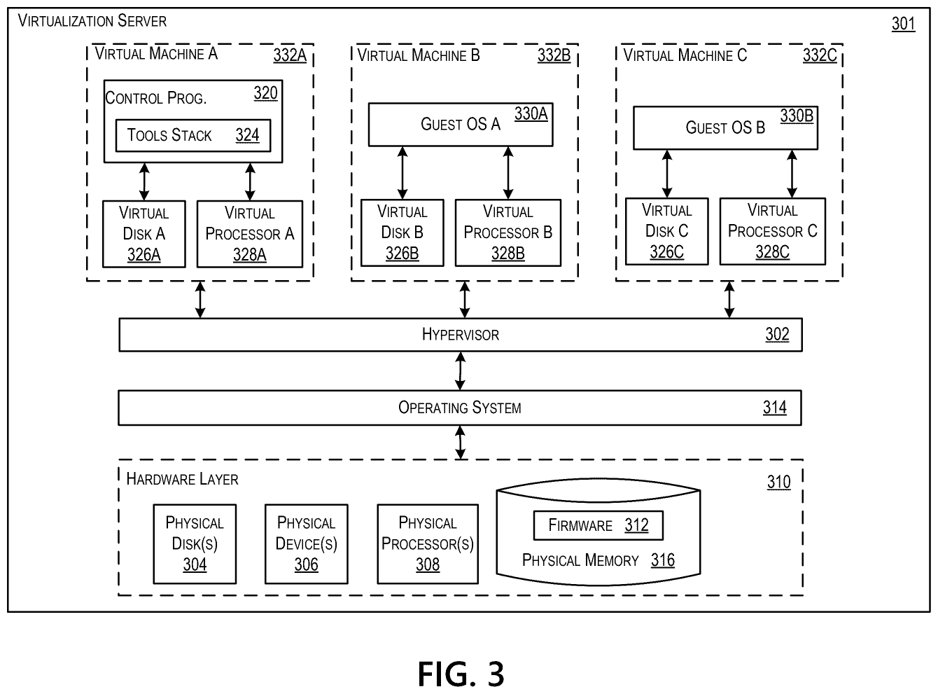

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMware, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

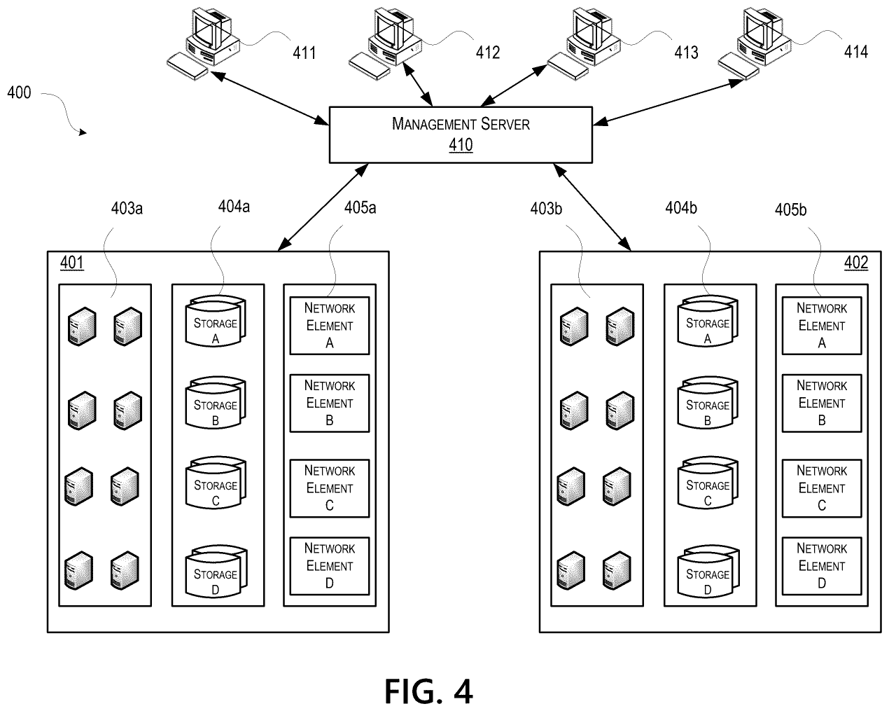

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on be of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### In Session Discovery of Packetization Layer Path Maximum Transmission Unit (PLPMTU) Size

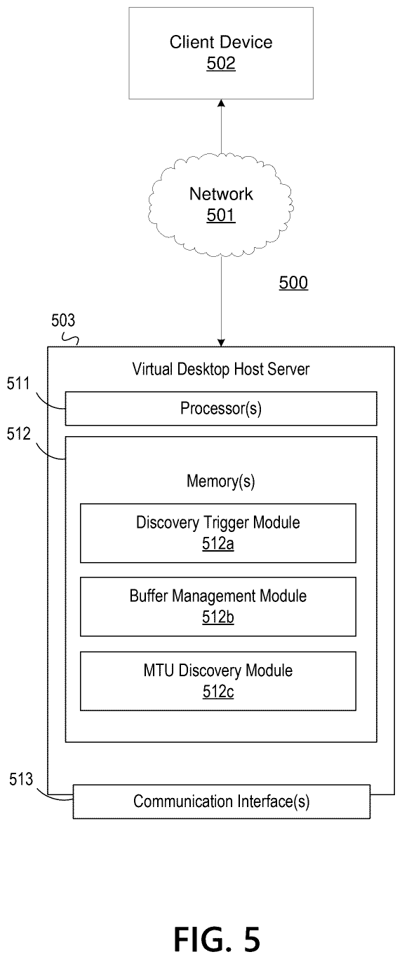

FIG. 5 depicts an illustrative computing environment for performing in session discovery of packetization layer path maximum transmission unit (PLPMTU) size in accordance with one or more example embodiments. Referring to FIG. 5, computing environment 500 may include one or more computer systems. For example, computing environment 500 may include a client device 502 and a virtual desktop host server 503.

As illustrated in greater detail below, client device 502 may be a personal computing device such as a smartphone, tablet, laptop computer, desktop computer, or the like. In some instances, client device 502 may be configured to facilitate the use of virtual desktops, virtual applications, or the like, and thus may be configured to communicate with the virtual desktop host server 503. Although a single client device is depicted, any number of such devices may be implemented in the methods described herein without departing from the scope of the disclosure.

Virtual desktop host server 503 may be a computer system that includes one or more computing devices (e.g., servers, server blades, or the like) and/or other computer components (e.g., processors, memories, communication interfaces). In one or more instances, virtual desktop host server 503 may be configured to host one or more virtual desktop applications and/or other virtual applications, and may be configured to communicate with one or more client devices (e.g., client device 502) to facilitate the use of such applications.

Computing environment 500 may also include one or more networks, which may interconnect client device 502 and virtual desktop host server 503. For example, computing environment 500 may include a wired or wireless network 501 (which may e.g., interconnect client device 502 and virtual desktop host server 503).

In one or more arrangements, client device 502, virtual desktop host server 503, and/or the other systems included in the computing environment may be any type of computing device capable of receiving a user interface, receiving input via the user interface, and communicating the received input to one or more other computing devices. For example, client device 502, virtual desktop host server 503, and/or the other systems included in the computing environment may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of client device 502 and virtual desktop host server 503 may, in some instances, be special purpose computing devices configured to perform specific functions.

Virtual desktop host server 503 may include one or more processors 511, memory 512, and communication interface 513. A data bus may interconnect processor 511, memory 512, and communication interface 513. Communication interface 513 may be a network interface configured to support communication between the virtual desktop host server 503 and one or more networks (e.g., network 501, or the like). Memory 512 may include one or more program modules having instructions that when executed by processor 511 cause virtual desktop host server 503 to perform one or more functions described herein and/or access one or more databases that may store and/or otherwise maintain information which may be used by such program modules and/or processor 511. In some instances, the one or more program modules and/or databases may be stored by and/or maintained in different memory units of virtual desktop host server 503 and/or by different computing devices that may form and/or otherwise make up virtual desktop host server 503. For example, memory 512 may have, host, store, and/or include instructions that direct and/or otherwise cause virtual desktop host server 503 to facilitate in session discovery of PLPMTU size. For example, the virtual desktop host server 503 may store and/or otherwise include discovery trigger module 512a, buffer management module 512b, and PLPMTU discovery module 512c. Discovery trigger module 512a may be configured to facilitate the identification of when to initiate PLPMTU discovery (e.g., using the PLPMTU discovery module 512c). Buffer management module 512b may be configured to facilitate the buffering and transmission of packets during the PLPMTU discovery. PLPMTU discovery module 512c may be configured to perform dynamic in session PLPMTU identification and modification.

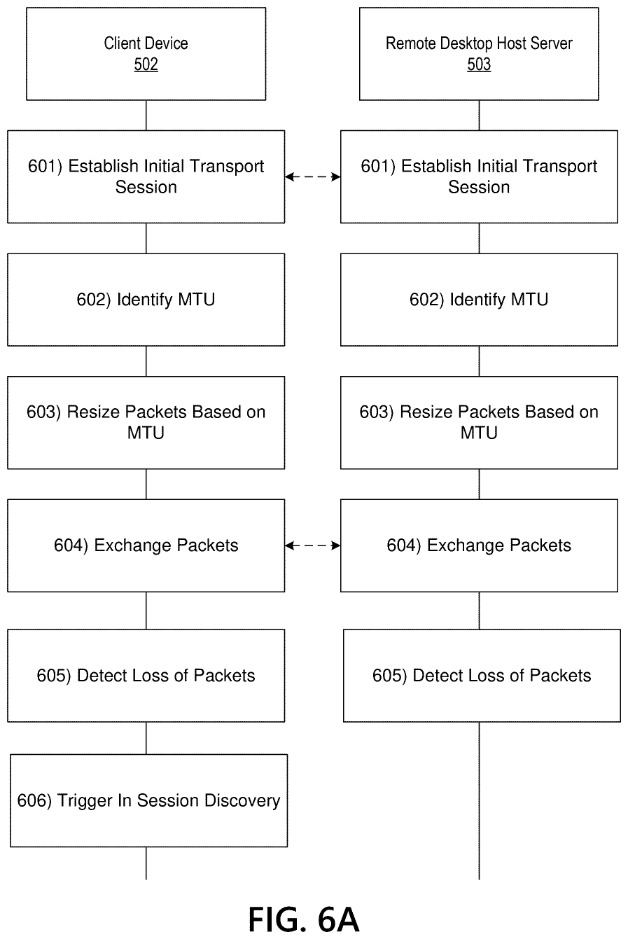

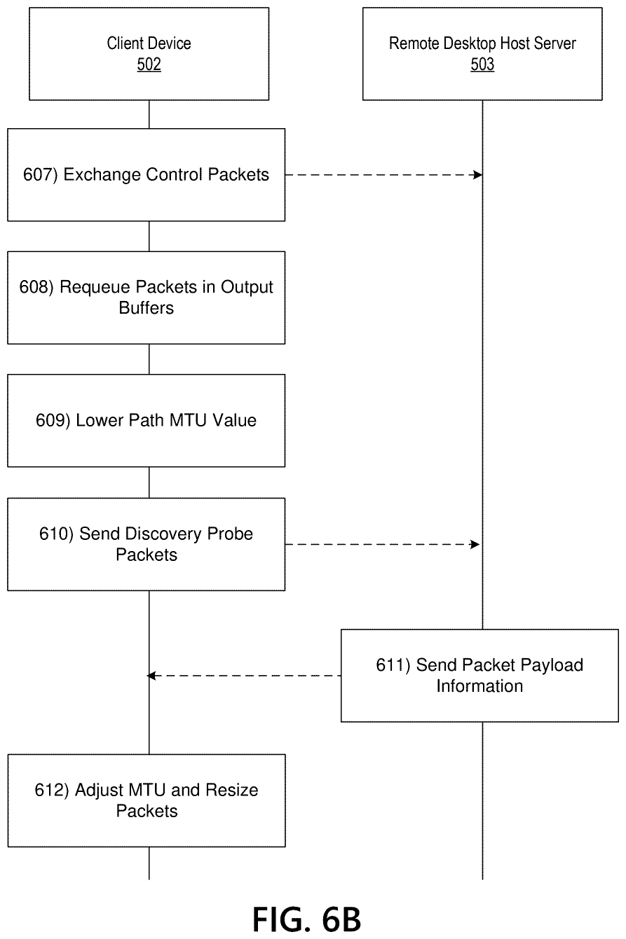

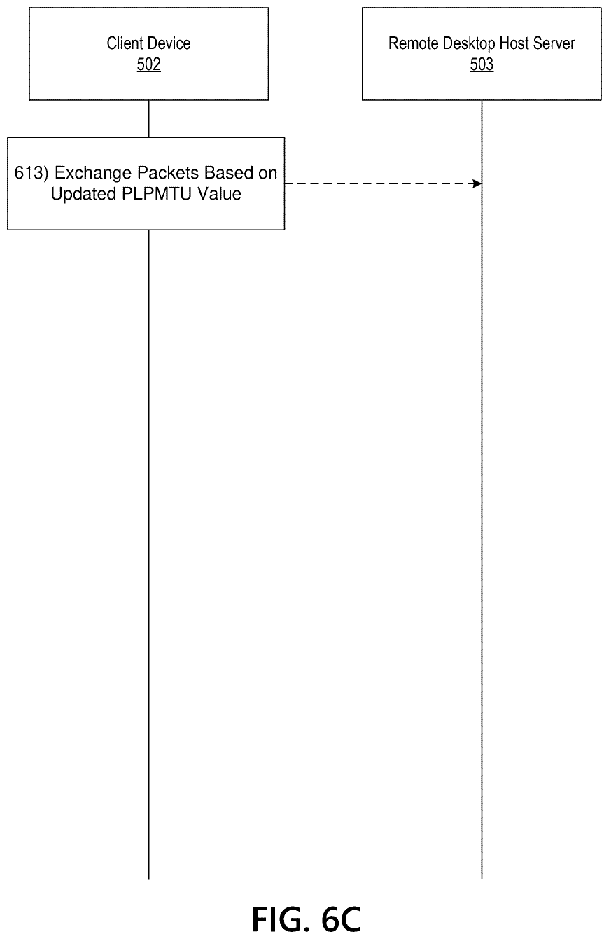

FIGS. 6A-6C depict an illustrative event sequence for performing in session discovery of packetization layer path maximum transmission unit (PLPMTU) size in accordance with one or more example embodiments. It should be understood that steps 601-613 may, in some instances, occur in the order as shown with regard to FIGS. 6A-6C. For example, after completing step 606 of FIG. 6A, the event sequence may proceed to step 607 of FIG. 6B. Similarly, after completing step 612 of FIG. 6B, the event sequence may proceed to step 613 of FIG. 6C.

Referring to FIG. 6A, at step 601, the client device 502 may communicate with the virtual desktop host server 503 to establish an initial transport session. For example, the client device 502 may establish a connection with the virtual desktop host server 503 that facilitates a remote and/or other virtual session that includes the transmission of IP packets between the client device 502 and the virtual desktop host server 503.

At step 602, the client device 502 and/or the virtual desktop host server 503 may perform, for the initial transport session established at step 601, PL-PMTU discovery. For example, the client device 502 and/or the virtual desktop host server 503 may identify a transmission path between the client device 502 and the virtual desktop host server 503, across which packets may travel at the start of the initial transport session. Additionally, the client device 502 and/or the virtual desktop host server 503 may identify, along this transmission path, a maximum transmission unit size for packets. For example, the client device 502 and/or the virtual desktop host server 503 may determine the MTU on the path (which may, e.g., vary along the path). The client device 502 and/or virtual desktop host server 503 may then set the PLPMTU as the minimum MTU value detected along this path. For example, by selecting the smallest maximum packet size supported along the path, the client device 502 and/or virtual desktop host server 503 may ensure that transmission of packets conforming with the selected PLPMTU is supported throughout the entire path.

In some instances, in identifying the PL-PMTU value, the client device 502 and/or the virtual desktop host server 503 may identify a maximum packet size (e.g., 1500 bytes, or the like). In some instances, this initial PL-PMTU discovery may identify an initial value, that may be dynamically adjusted throughout the lifetime of the session as is described further below.

At step 603, the client device 502 and/or virtual desktop host server 503 may resize packets based on the PLPMTU identified at step 602. For example, if a PLPMTU value of 1500 bytes was identified, the client device 502 and/or virtual desktop host server 503 may generate data packets that comply with this limitation. In some instances, the PLPMTU value may represent a maximum packet size limitation. However, it may be advantageous to also size packets as close to the PLPMTU value as possible for efficiency (e.g., it may be inefficient to transmit packets sized significantly below the PLPMTU value).

At step 604, the client device 502 and/or virtual desktop host server 503 may begin exchanging packets sized according to the initial PLPMTU. For example, this exchange may occur while the initial transport session is still established. In this exchange, because packets have been appropriately sized to comply with the PLPMTU, packets might not be fragmented and/or otherwise lost along the transmission path.

At step 605, the client device 502 and/or virtual desktop host server 503 may identify a loss of packets. For example, at some point during the transport session, the transmission path may have been modified from the original transmission path identified at step 602. For example, the transmission path may be modified by cloud network nodes over which the transport session is established, or the like. This may, for example, cause packets to be dropped. For example, the initial connection may have been established over a first transmission path with a PLPMTU of 1500 bytes, which was discovered at the start of the session and packet sizes may have been set accordingly (as is described above). Now, as the session is in progress, the cloud network nodes may have decided to route packets across a different path, which may, e.g., have a different PLPMTU (e.g., 1200 bytes, or the like, which might not be known to the client device 502 and/or virtual desktop host server 503). This may cause packets over the size of the new PLPMTU to be fragmented at an IP layer or even dropped based on how the intermediary nodes handle fragmentation. Additionally or alternatively, gateway nodes may silently switch the session from one point-of-presence (POP) to another due to planned or unplanned shutdown, which may cause similar packet loss. In either event, this may cause performance degradation if not addressed.

At step 606, based on the detection of lost packets described at step 605, the client device 502 may trigger a rediscovery process to identify a new PLPMTU. In some instances, the client device 502 may trigger the rediscovery based on detecting sizes of packets that are retransmitted due to loss. For example, the client device 502 may identify that only packets above a particular threshold size value (which may, e.g., be representative of the new PLPMTU) are being retransmitted. As a result, the client device 502 may identify that packets above a particular size are being lost, and may trigger rediscovery accordingly.

Additionally or alternatively, each time a failed or lost packet is detected, the client device 502 amay increase a failure count value. As the client device 502 continues to increase the failure count value in response to detection of failed packets, it may compare the failure count value to a threshold value (e.g., three packet failures detected, or the like). Upon detecting that the failure count equals the threshold value, the client device 502 may trigger in session discovery.

Additionally or alternatively, the client device 502 may receive a selective acknowledgement (SACK) that may distinguish small packets that have arrived, and comprise a portion of a larger packet, which has been lost. Additionally or alternatively, a negative acknowledgement (NAK) may be sent. In these instances, the sender may identify that if the NAKs are being received for packets of a particular size (e.g., above some threshold value) whereas acknowledgements (ACKs) are being received for packets of a smaller size (e.g., below the threshold value), the PLPMTU has been reduced, and may trigger the in session discovery. In some instances, a list of failing packets may be maintained, and any packet for which an ACK was received may be removed from this list.

Additionally or alternatively, when sending a packet with the Don't Fragment bit set, the sender may receive an internet control message protocol (ICMP) packet-too-big message, which indicates that fragmentation has occurred. In these instances, the transmitted packet are lost, and the client device 502 may trigger the in session discovery accordingly.

In performing the in session discovery, the client device 502 may select a starting size for the PLPMTU, which may, e.g., correspond to a size of the largest packet for which a selective ACK was received, for which no NAK was received, or the like (which may, e.g., be based on the corresponding protocol scheme). Additionally or alternatively, this PLPMTU value may be selected based on historical information/patterns such as device information, time information, network conditions, machine identifiers, and/or other information. For example, in some instances, a rediscovery log may be maintained that may include such information in addition to the corresponding PLPMTUs that were selected. In some instances, in selecting this PLPMTU value, the client device 502 may set both upper and lower limits that may be used as a range of potential PLPMTU values to be tested. For example, while the upper boundary may be based on failing packet size (e.g., where no ACK message was received even with retransmission for a threshold number of times, such as three). Since multiple packets with sizes greater than the selected PMTU and less than the original PMTU may fail while waiting for this threshold number of failures to occur, an upper bound corresponding to the smallest of these failing packets may be selected. In doing so, the discovery range may be closer to the new PMTU that is being identified. Similarly, the largest packet size that was acknowledged while waiting for the threshold number of failures may be chosen as the lower bound. As a particular example, if failures were detected for packets of sizes 1350, 1400, and 1425 bytes respectively, and packets of sizes 1100, 1150, and 1200 were acknowledged, rediscovery may be issued for an open range of 1200 (lower bound) to 1350 (upper bound).

Referring to FIG. 6B, at step 607, while the in session discovery is being performed, the client device 502 may perform in session buffer management. For example, initial PLPMTU discovery may have been performed at the start of the session (e.g., as is described above at step 602). During such initial discovery, initial buffer sizes may be chosen that are small enough to be in accordance with minimum supported MTUs in most networks. As the in session discovery is performed, the buffers may be resized according to the newly discovered PLPMTU before larger packets are queued and sent. As described above, in session discovery may involve reducing PLPMTU size while the session is in progress, and may be triggered due to the loss of large sized packets, which may have already been added to a send queue-buffer for the transport session.

In order to perform the in session discovery, any packets that are suspected as being too large for the new PLPMTU may be sent. While the new MTU is being identified via the in session discovery process, smaller packets corresponding to a minimum identified PLPMTU may be sent (e.g., 1000 bytes, or the like).

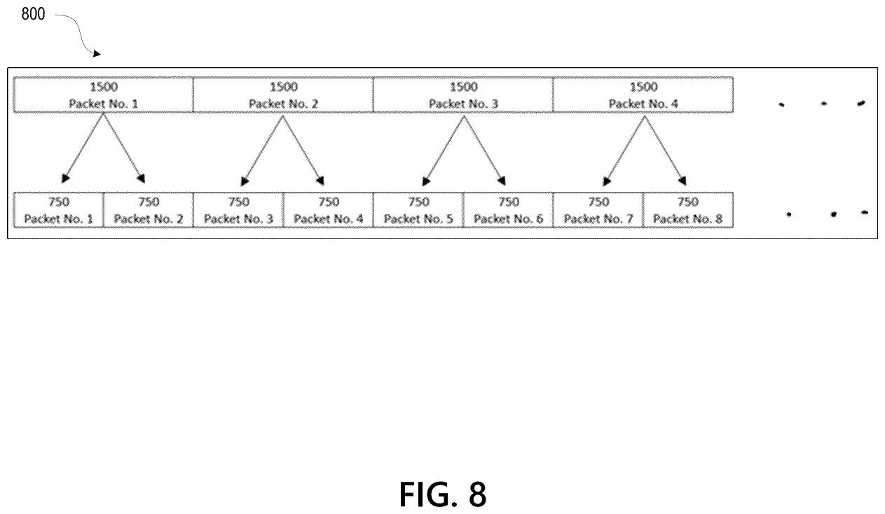

If there are buffers above a given threshold size, they may be handled in session so as to be resized to comply with the reduced transport PLPMTU. For example, as shown in diagram 800 of FIG. 8, queued packets of a size 1500 bytes may be split in, each producing two 750 byte packets. In some instances (as shown in FIG. 8), this may result in changes in sequence numbers of the packets that may already be in the queue and sequence number of packets that may have been lost. Accordingly, a control packet may be sent between the client device 502 and the virtual desktop host server 503, which may, e.g., be used to synchronize the sequence numbers.

At step 608, the client device 502 may re-queue packets in the send buffers and/or the lost buffers according to the sequence numbers. In some instances, these re-queued packets may comply with the reduced PLPMTU. For example, as illustrated in diagram 800, packet numbers one and two may be split into four packets, labelled one through four, respectively.

At step 609, the client device 502 may lower the PLPMTU value from the initial value identified at step 602 based on the size of the re-queued packets. By reducing the packet size/PLPMTU in this way, packets may be continuously transmitted without waiting for completion of the in session discovery process (which may effectively identify a most optimal PLPMTU size).

At step 610, returning to the in session discovery process, using the starting size for the PLPMTU selected at step 606, the client device 502 may send discovery probe packets corresponding to this size. For example, the client device 502 may send the discovery probe packets to the virtual desktop host server 503 to test whether or not the corresponding packet size is acceptable as the PLPMTU.

At step 611, upon receiving discovery probe packets sent at 610, the desktop host server 503 may send response packet information back to the client device 502. For example, the virtual desktop host server 503 may send information indicating whether or not the discovery probe packets were fragmented, lost, and/or otherwise compromised along the transmission path (e.g., because they are too large, or the like).

In instances where the response packet information or lack of response packet thereof, indicates that the size of the discovery probe packets was too large, the client device 502 may return to step 606 to update the PLPMTU and resize packets accordingly (e.g., reduce size). In some instances, the client device 502 may wait for more than a threshold number (e.g., three, or the like) of fragmented or failed packets to be detected prior to returning to step 606. In these instances, the lowest size of a failing packet may be selected as the upper bound for the in session discovery. Otherwise, if the response packet information indicates that the size of the discovery probe packets was sufficient, the client device 502 may proceed to step 612.

At step 612, the client device 502 may resize the PLPMTU values and output buffers according to the new PLPMTU value. For example, the client device 502 amay cause packets in the output buffers and any future packets to be generated to comply with the size indicated in the new PLPMTU value. In some instances, the client device 502 may renumber packets that have been resized, and may re-synchronize, following the renumbering, a packet number to signal an initial packet and discards out of order packets that were not renumbered.

Referring to FIG. 6C, at step 613, the client device 502 may exchange packets based on the updated PLPMTU value. In doing so, the client device 502 may continue to exchange packets in the same session, without experiencing the loss of packet information detected at step 605 (which may, e.g., avoid degradation in performance and/or increased latencies) due to changes in path over the lifetime of a session and/or otherwise. Furthermore, because the PLPMTU is resized through the in session discovery, steps such as re-authentication, resource identification, re-authorization, or the like may be avoided.

Although the above described event sequence occurs during a single transport session, in some instances, a separate transport session may be established between the same endpoints from time to time, and may be tested to determine if the loss in the network is better in that session. If so, the session may be switched over accordingly.

Furthermore, although the in-session discovery described above with regard to steps 606-614 is depicted as being performed by the client device 502, such discovery may be performed by the remote desktop host server 503 without departing from the scope of the disclosure.

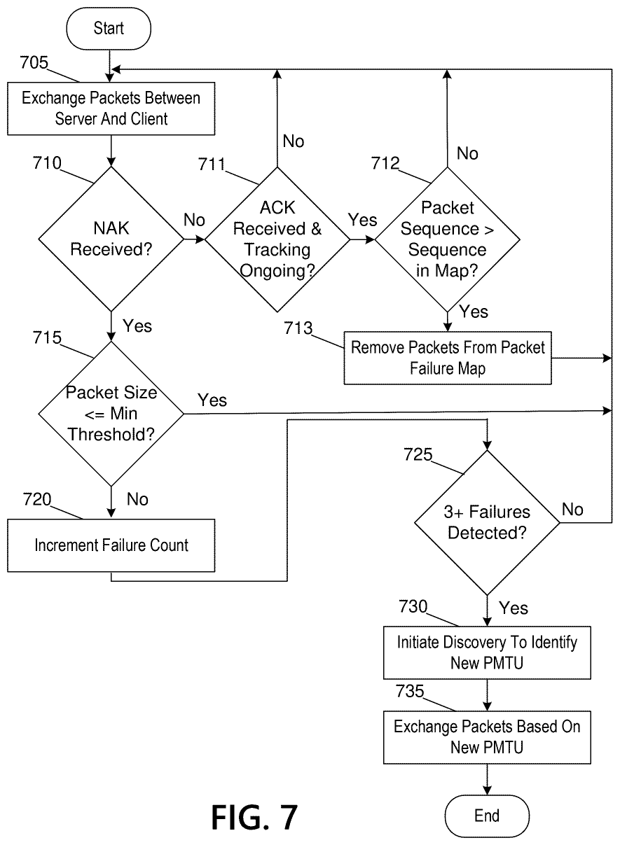

FIG. 7 depicts an illustrative method for performing in session discovery of packetization layer path maximum transmission unit (PLPMTU) size in accordance with one or more example embodiments. Referring to FIG. 7, at step 705, a computing system comprising a memory and one or more processors may exchange packets between a client and server. In some instances, any failures may be recorded in a packet failure map. At step 710, the computing system may identify whether a NAK and/or other indication of a failed packet transmission is detected. If not, the computing system may proceed to step 711. Otherwise, if a NAK and/or other indication of a failed packet transmission is detected, the computing system may proceed to step 715.

At step 711, the computing system may identify whether or not an ACK was received and whether failure tracking is ongoing (e.g., whether a packet failure map is not empty). If so, the computing system may proceed to step 712. Otherwise, the computing system may return to step 705. At step 712, the computing system may identify whether the ACK packet sequence is greater than the sequence in the packet failure map. If so, the computing system may proceed to step 713. Otherwise, the computing system may return to step 705. At step 713, the computing system may remove all packets with sequence numbers less than the sequence number in the ACK from the packet failure map. The computing system may then return to step 705. In doing so, the failure count may be reset to zero when necessary.

At step 715, the computing system may identify whether the packet size is less than or equal to a minimum threshold. For example, this minimum threshold may be selected based on a packet size known to work (e.g., based on network parameters, standards, or the like), such as 1024 bytes or the like. By selecting such a minimum size, packet failures of packets that are less than the minimum size may be considered transient network issues rather than limitations of the network itself. If so, the computing system may return to step 705. Otherwise, if the packet size is greater than the minimum threshold, the computing system may proceed to step 720. At step 720, the computing system may increment a failure count. At step 725, the computing system may identify whether a threshold (e.g., at least three) number of failures have been detected. If the threshold number of failures has not been detected, the computing system may return to step 705. If the threshold number of failures has been detected, the computing system may proceed to step 730. At step 730, the computing system may initiate discovery to identify a new PLPMTU. At step 735, the computing system may exchange packets according to the new PLPMTU.

The following paragraphs (M1) through (M13) describe examples of methods that may be implemented in accordance with the present disclosure.

(M1) A method comprising: establishing, by a first device comprising one of a client device or a server, a packet transport session, wherein the packet transport session is established between the client device and the server; detecting, by the first device and during the packet transport session, that a threshold number of packets have failed to successfully transmit between the client device and the server, wherein a size of each of the failed packets exceeds a predetermined size, and wherein the packets are transmitted according to a first maximum transmission unit (MTU); identifying, by the first device, while continuing to transmit additional packets during the packet transport session, and based on a largest packet that successfully travelled between the client device and the server, a second MTU, smaller than the first MTU; resizing, by the first device and during the packet transport session, further packets according to the second MTU; and transmitting, by the first device and during the packet transport session, the further packets between the client device and the server.

(M2) The method as described in paragraph (M1), further comprising: identifying that a negative acknowledgement (NAK) is received for a first packet, and identifying, based on the NAK, that the first packet failed to successfully transmit between the client device and the server.

(M3) The method as described in paragraph (M2), further comprising: identifying whether a size of the first packet exceeds a minimum threshold; and based on identifying that the size of the first packet exceeds the minimum threshold, triggering a rediscovery process to identify the second MTU.

(M4) The method as described in paragraphs (M1) through (M3), wherein detecting that the threshold number of packets have failed to successfully transmit between the client device and the server comprises: increasing, each time a failed transmission is detected, a failure count; and identifying that the failure count equals the threshold number.

(M5) The method as described in any of paragraphs (M1) through (M4), further comprising: splitting an original packet into multiple smaller packets, wherein the detection that the threshold number of packets have failed to successfully transmit between the client device and the server occurs during the transmission of the original packet, and transmitting the multiple smaller packets rather than the original packet, wherein the multiple smaller packets are successfully transmitted between the client device and the server.

(M6) The method as described in paragraph (M5), wherein: an upper protocol uses packet numbers, the multiple smaller packets are renumbered once the original packet is split, and the upper protocol re-synchronizes, following the renumbering, a packet number to signal an initial packet and discards out of order packets that were not renumbered.

(M7) The method as described in any of paragraphs (M1) through (M6), wherein identifying the second MTU, smaller than the first MTU occurs during a MTU discovery process, and wherein initiating the MTU discovery process is based on identifying that a plurality of packets to be retransmitted exceed the predetermined size.

(M8) The method as described in any of paragraphs (M1) through (M7), wherein identifying the second MTU, smaller than the first MTU occurs during a MTU discovery process, and wherein initiating the MTU discovery process is based on detecting an increase in a number of lost packets.

(M9) The method as described in any of paragraphs (M1) through (M8), wherein identifying the second MTU, smaller than the first MTU occurs during a MTU discovery process, and wherein initiating the MTU discovery process is based on detecting an internet control message protocol (ICMP) packet-too-big message.

(M10) The method as described in any of paragraphs (M1) through (M9), wherein the largest packet is identified based on an acknowledgement (ACK) message received for the largest packet.

(M11) The method as described in any of paragraphs (M1) through (M10), wherein the largest packet is identified based on identifying that the largest packet comprises a largest packet for which a NAK is not received.

(M12) The method as described in any of paragraphs (M1) through (M11), wherein: identifying the second MTU comprises identifying, based on a lower bound and an upper bound, the second MTU, the lower bound and the upper bound are identified while waiting for a threshold number of packet transmission failures, the upper bound is identified based on a packet size of a smallest packet for which failure is detected while waiting for the threshold number of packet transmission failures, and the lower bound is identified based on a packet size of a largest packet acknowledged while waiting for the threshold number of packet transmission failures.

(M13) The method as described in any of paragraphs (M1) through (M12), wherein identifying the second MTU is further based on: historical information including one or more of: device information, time information, network condition information, or machine identifier information, and corresponding final MTU information.

The following paragraphs (A1) through (A6) describe examples of computing systems that may be implemented in accordance with the present disclosure.

(A1) A computing system comprising: one or more processors; memory storing computer executable instructions that, when executed by the processor, cause the computing system to: establish a packet transport session, wherein the computing system comprises one of a client device or a server, and wherein the packet transport session is established between the client device and the server; detect, while continuing to transmit additional packets during the packet transport session, that a threshold number of packets have failed to successfully transmit between the client device and the server, wherein a size of each of the failed packets exceeds a predetermined size, and wherein the packets are transmitted according to a first maximum transmission unit (MTU); identify, during the packet transport session and based on a largest packet that successfully travelled between the client device and the server, a second MTU, smaller than the first MTU; resize, during the packet transport session, further packets according to the second MTU; and transmit, during the packet transport session, the further packets between the client device and the server.

(A2) The computing system of paragraph (A1), wherein the memory stores computer executable instructions that, when executed by the processor, cause the computing system to: identify that a negative acknowledgement (NAK) is received for a first packet, and identify, based on the NAK, that the first packet failed to successfully transmit between the client device and the server.

(A3) The computing system of paragraph (A2), wherein the memory stores computer executable instructions that, when executed by the processor, cause the computing system to: identify whether a size of the first packet exceeds a minimum threshold; and based on identifying that the size of the first packet exceeds the minimum threshold, trigger a rediscovery process to identify the second MTU.

(A4) The computing system of any one of paragraphs (A1) through (A3), wherein detecting that the threshold number of packets have failed to successfully transmit between the client device and the server comprises: increasing, each time a failed transmission is detected, a failure count; and identifying that the failure count equals the threshold number.

(A5) The computing system of any one of paragraphs (A1) through (A4) wherein the memory stores computer executable instructions that, when executed by the processor, cause the computing system to: split an original packet into multiple smaller packets, wherein the detection that the threshold number of packets have failed to successfully transmit between the client device and the server occurs during the transmission of the original packet, and transmit the multiple smaller packets rather than the original packet, wherein the multiple smaller packets are successfully transmitted between the client device and the server.

(A6) The computing system of paragraph (A5), wherein: an upper protocol uses packet numbers, the multiple smaller packets are renumbered once the original packet is split, and the upper protocol re-synchronizes, following the renumbering, a packet number to signal an initial packet and discards out of order packets that were not renumbered.

The following paragraph (CRM1) describes examples of computer-readable media that may be implemented in accordance with the present disclosure.

(CRM1) One or more non-transitory computer-readable media storing instructions that, when executed by a computing system comprising at least one processor, a communication interface, and memory, cause the computing system to: establish a packet transport session, wherein the computing system comprises one of a client device or a server, and wherein the packet transport session is established between the client device and the server; detect, while continuing to transmit additional packets during the packet transport session, that a threshold number of packets have failed to successfully transmit between the client device and the server, wherein a size each of the failed packets exceeds a predetermined size, and wherein the packets are transmitted according to a first maximum transmission unit (MTU); identify, during the packet transport session and based on a largest packet that successfully travelled between the client device and the server, a second MTU, smaller than the first MTU; resize, during the packet transport session, further packets according to the second MTU; and transmit, during the packet transport session, the further packets between the client device and the server.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
establishing, by a first device comprising one of a client device or a server, a packet transport session, wherein the packet transport session is established between the client device and the server;
detecting, by the first device and during the packet transport session, that a threshold number of packets have failed to successfully transmit between the client device and the server, wherein a size of each of the failed packets exceeds a predetermined size, and wherein the packets are transmitted according to a first maximum transmission unit (MTU);
identifying, by the first device, while continuing to transmit additional packets during the packet transport session, and based on a largest packet that successfully travelled between the client device and the server, a second MTU, smaller than the first MTU;
resizing, by the first device and during the packet transport session, further packets according to the second MTU; and
transmitting, by the first device and during the packet transport session, the further packets between the client device and the server.

2. The method of claim 1, further comprising:
identifying that a negative acknowledgement (NAK) is received for a first packet, and
identifying, based on the NAK, that the first packet failed to successfully transmit between the client device and the server.

3. The method of claim 2, further comprising:
identifying whether a size of the first packet exceeds a minimum threshold; and
based on identifying that the size of the first packet exceeds the minimum threshold, triggering a rediscovery process to identify the second MTU.

4. The method of claim 1, wherein detecting that the threshold number of packets have failed to successfully transmit between the client device and the server comprises:
increasing, each time a failed transmission is detected, a failure count; and
identifying that the failure count equals the threshold number.

5. The method of claim 1, further comprising:
splitting an original packet into multiple smaller packets, wherein the detection that the threshold number of packets have failed to successfully transmit between the client device and the server occurs during the transmission of the original packet, and
transmitting the multiple smaller packets rather than the original packet, wherein the multiple smaller packets are successfully transmitted between the client device and the server.

6. The method of claim 5, wherein:
an upper protocol uses packet numbers,
the multiple smaller packets are renumbered once the original packet is split, and
the upper protocol re-synchronizes, following the renumbering, a packet number to signal an initial packet and discards out of order packets that were not renumbered.

7. The method of claim 1, wherein identifying the second MTU, smaller than the first MTU occurs during a MTU discovery process, and wherein initiating the MTU discovery process is based on identifying that a plurality of packets to be retransmitted exceeds the predetermined size.

8. The method of claim 1, wherein identifying the second MTU, smaller than the first MTU occurs during a MTU discovery process, and wherein initiating the MTU discovery process is based on detecting an increase in a number of lost packets.

9. The method of claim 1, wherein identifying the second MTU, smaller than the first MTU occurs during a MTU discovery process, and wherein initiating the MTU discovery process is based on detecting an internet control message protocol (ICMP) packet-too-big message.

10. The method of claim 1, wherein the largest packet is identified based on an acknowledgement (ACK) message received for the largest packet.

11. The method of claim 1, wherein the largest packet is identified based on identifying that the largest packet comprises a largest packet for which a NAK is not received.

12. The method of claim 1, wherein:
identifying the second MTU comprises identifying, based on a lower bound and an upper bound, the second MTU,
the lower bound and the upper bound are identified while waiting for a threshold number of packet transmission failures,
the upper bound is identified based on a packet size of a smallest packet for which failure is detected while waiting for the threshold number of packet transmission failures, and
the lower bound is identified based on a packet size of a largest packet acknowledged while waiting for the threshold number of packet transmission failures.

13. The method of claim 1, wherein identifying the second MTU is further based on:
historical information including one or more of: device information, time information, network condition information, or machine identifier information, and
corresponding final MTU information.

14. A computing system comprising:
one or more processors;
memory storing computer executable instructions that, when executed by the processor, cause the computing system to:
establish a packet transport session, wherein the computing system comprises one of a client device or a server, and wherein the packet transport session is established between the client device and the server;
detect, during the packet transport session, that a threshold number of packets have failed to successfully transmit between the client device and the server, wherein a size of each of the failed packets exceeds a predetermined size, and wherein the packets are transmitted according to a first maximum transmission unit (MTU);
identify, while continuing to transmit additional packets during the packet transport session and based on a largest packet that successfully travelled between the client device and the server, a second MTU, smaller than the first MTU;
resize, during the packet transport session, further packets according to the second MTU; and
transmit, during the packet transport session, the further packets between the client device and the server.

15. The computing system of claim 14, wherein the memory stores additional computer executable instructions that, when executed by the processor, cause the computing system to:
identify that a negative acknowledgement (NAK) is received for a first packet, and
identify, based on the NAK, that the first packet failed to successfully transmit between the client device and the server.

16. The computing system of claim 15, wherein the memory stores additional computer executable instructions that, when executed by the processor, cause the computing system to:
identify whether a size of the first packet exceeds a minimum threshold; and
based on identifying that the size of the first packet exceeds the minimum threshold, trigger a rediscovery process to identify the second MTU.

17. The computing system of claim 14, wherein detecting that the threshold number of packets have failed to successfully transmit between the client device and the server comprises:
increasing, each time a failed transmission is detected, a failure count; and
identifying that the failure count equals the threshold number.

18. The computing system of claim 14, wherein the memory stores additional computer executable instructions that, when executed by the processor, cause the computing system to:
split an original packet into multiple smaller packets, wherein the detection that the threshold number of packets have failed to successfully transmit between the client device and the server occurs during the transmission of the original packet, and
transmit the multiple smaller packets rather than the original packet, wherein the multiple smaller packets are successfully transmitted between the client device and the server.

19. The computing system of claim 18, wherein:
an upper protocol uses packet numbers,
the multiple smaller packets are renumbered once the original packet is split, and
the upper protocol re-synchronizes, following the renumbering, a packet number to signal an initial packet and discards out of order packets that were not renumbered.

20. One or more non-transitory computer-readable media storing instructions that, when executed by a computing system comprising at least one processor, a communication interface, and memory, cause the computing system to:
establish a packet transport session, wherein the computing system comprises one of a client device or a server, and wherein the packet transport session is established between the client device and the server;
detect, during the packet transport session, that a threshold number of packets have failed to successfully transmit between the client device and the server, wherein a size each of the failed packets exceeds a predetermined size, and wherein the packets are transmitted according to a first maximum transmission unit (MTU);
identify, while continuing to transmit additional packets during the packet transport session and based on a largest packet that successfully travelled between the client device and the server, a second MTU, smaller than the first MTU;
resize, during the packet transport session, further packets according to the second MTU; and
transmit, during the packet transport session, the further packets between the client device and the server.
